(19) United States
(12) Patent Application Publication
(10) Pub. No.: US 2024/0210442 A1
(43) Pub. Date: Jun. 27, 2024

(54) METHOD OF CALIBRATING IN A SCANNING PROBE MICROSCOPY SYSTEM AN OPTICAL MICROSCOPE, CALIBRATION STRUCTURE AND SCANNING PROBE MICROSCOPY DEVICE

(71) Applicant: Nearfield Instruments B.V., Rotterdam (NL)

(72) Inventors: Taras PISKUNOV, Schiedam (NL); Hamed SADEGHIAN MARNANI, Rotterdam (NL); Erik TABAK, Rotterdam (NL)

(21) Appl. No.: 18/288,660

(22) PCT Filed: Apr. 28, 2022
(86) PCT No.: PCT/NL2022/050228

§ 371 Date: Oct. 27, 2023

(30) Foreign Application Priority Data
Apr. 29, 2021 (NL) 2028090

(51) Int. Cl. G01Q 40/00; G01Q 20/02; G01Q 30/02; G01Q 30/06

(52) U.S. Cl. CPC G01Q 40/00; G01Q 20/02; G01Q 30/025; G01Q 30/06

(57) ABSTRACT

The present document relates to a method of calibrating, in a scanning probe microscopy system, an optical microscope. The optical microscope is configured for providing a reference data for positioning a probe tip on a surface of a substrate. The calibration is performed using a calibration structure being a spatial structure including features at different Z-levels relative to a Z-axis, the Z-axis being perpendicular to the surface of the substrate. The method comprises a step of obtaining, with the optical microscope, at least two images of at least a part of the calibration structure. The at least two images are focused in at least two different levels of the Z-levels. The method further comprises a step of determining a lateral shift, in a direction perpendicular to the Z-axis, of the calibration structure as depicted in the at least two images focused in the at least two different levels. The invention is further directed at a calibration structure, a substrate carrier and scanning probe microscopy device.

### FIELD OF THE INVENTION

The present invention is directed at a method of calibrating, in a scanning probe microscopy system, an optical microscope. The invention is further directed at a calibration structure, a substrate carrier and scanning probe microscopy device.

### BACKGROUND

Scanning probe microscopy (SPM) enables to obtain a highly accurate image of a very small part of a surface. The image can be a surface topography image or a subsurface topography image, or even a combination thereof that visualizes multiple layers, which may be surface layers or layers at different depths below a surface. The technology enables to image surface areas having typical cross sections in the order of 0.001 to 100 micrometers (μm). Because of this scale and accuracy, the technology is a suitable candidate for enabling wafer inspection, i.e. for monitoring of the manufacturing process of semiconductor elements during fabrication thereof.

Given the scale of the image in relation to the size of a typical wafer, it is essential to have a highly accurate positioning system that enables to accurately position the probe tip of the SPM in the desired location on the surface of the wafer for performing the scanning. In an industrial application, e.g. during a semiconductor manufacturing process, maximum yield of the production process is a further requirement in addition to the required high level of accuracy. Hence, ideally the probe tip is accurately placed in the desired location as fast as possible to start scanning and to minimize the delay caused by the positioning process.

Various techniques for positioning a probe tip on the surface of a substrate are available. A number of these techniques thereby make use of optical microscopes to contribute in the positioning process. Apart from positioning, optical microscopes or sensors requiring optics may also be applied during scanning for various reasons. Typically, an SPM system comprises an internal positioning reference, such as a grid plate, to very accurately know the location of the probe tip in the system, i.e. relative to the substrate carrier. For enabling positioning on a location of a wafer, an optical microscope may be applied to relate the position of the probe tip in the system to an exact location on the wafer surface. Clearly, any information obtained from the microscope image is required to be exact enough in order to enable accurate placement in the desired location on the typical scale involved with the largest magnification factors. Hence accurate calibration of the equipment therefore is therefore of great importance. This is a difficult process in view of the desired accuracy.

### SUMMARY OF THE INVENTION

It is an object of the present invention to provide an accurate calibration method for the optical microscope of a scanning probe microscopy system, which in particular enables to reduce inaccuracies in the determination of an XY position on the surface of a wafer.

To this end, there is provided herewith a method of calibrating, in a scanning probe microscopy system, an optical microscope configured for providing a reference data for positioning a probe tip on a surface of a substrate, wherein the calibration is performed using a calibration structure being a spatial structure including features at different Z-levels relative to a Z-axis, the Z-axis being perpendicular to the surface of the substrate, wherein the method comprises the steps of: obtaining, with the optical microscope, at least two images of at least a part of the calibration structure, wherein the at least two images are focused in at least two different levels of the Z-levels; and determining a lateral shift, in a direction perpendicular to the Z-axis, of the calibration structure as depicted in the at least two images focused in the at least two different levels.

On the geometrical scale of interest of the optical microscope (tens of micrometers), a substrate (such as a wafer) is far from being a flat surface. As a result, an optical microscope that is used inter alia for correctly positioning a probe tip on a substrate surface in an SPM system, must be refocused frequently dependent on the local height of the substrate surface. For focusing, a focusing objective in the microscope must be accurately moved along the optical axis of the microscope. Typically, a precision actuator element is applied in order to move the focusing objective along the optical axis. However, regardless of its accuracy, along its path along the optical axis the precision actuator will typically introduce some lateral displacement from the optical axis. Such lateral displacement will introduce an uncertainty in the determined XY position on the wafer, due to the image shifting on e.g. an imaging screen. The method of the present invention applies a multilevel calibration structure to enable measuring of this lateral shift at different Z-levels for focusing. In lens systems, focusing is achieved by moving a lens in the direction of the optical axis relative to an imaging screen (e.g. a CCD cell of a camera). Typically, to achieve the desired accuracy, movement of the lens for this purpose is achieved by an actuator. Because the amount of achievable accuracy is limited, this motion cannot be achieved without a certain lateral displacement. Thus, a lateral shift in the image which is dependent on the focusing will occur to some extent.

In accordance with the method, at least two images of the calibration structure or a part thereof are obtained with the optical microscope. These images are focused in at least two different levels of the Z-levels of the multilevel calibration structure. For example, by focusing on different features having edges or other optically visible elements located at different Z-levels, different images are obtained wherein the focusing objective is differently focused with the precision actuator element. From these images, a lateral shift of the calibration structure in a direction perpendicular to the Z-axis, as depicted in the images focused in the at least two different levels, is determined. This lateral shift may be used by the SPM system as calibration data in relation to the different focusing levels. The invention thereby is able to correct images obtained with the optical microscope to be corrected for lateral displacement caused by refocusing of the optical elements. There may be various sources that can cause such lateral displacements or shifts in the images obtained. One of these causes is the precision actuator that is used for moving the objective between different focusing distances. Although the objective, for this refocusing, may be translated accurately in the direction along the optical path therethrough, tiny imperfections in the actuator result in small off-axis shifts of the objective which displace the image formed on the screen of a camera or optical sensor. However, to the scanning probe microscope (SPM), such displacements add to inaccuracy in the determination of a location on the surface of a sample. As may be appreciated, any source of inaccuracy is to be eliminated where possible in order to achieve the desired accuracy of an SPM system, which is in the order of tens of nanometers. The optical microscope in an SPM system amongst others plays a role in rough positioning and calibration of the system, such as the determination of the exact positions of fiducial markers or certain features. An as accurate determination as possible prevents errors in positioning of the probe tip, amongst others.

In some embodiments, the step of obtaining at least two images is performed by obtaining a series of images of the calibration structure during a refocusing of the optical microscope across a range of Z-levels, and wherein the step of determining a lateral shift is performed by detecting a moving of the calibration structure across the series of images. If a series of images are obtained, variation in lateral shift is indicative of the sideways, i.e. off-axis, motion of the objective from the optical path due to the precision actuator. It is to be noted that off-axis motion from the optical path is not the sole potential cause of lateral shift. Lens imperfections, imperfections in other parts of the optics, or temperature variations may likewise cause such lateral shifts. The present invention enables to quantify those lateral shifts that are cause by more or less static or semi-static sources, which do not vary during the time wherein measurements are performed. System originated errors are an example of this, but similarly, in a controlled environment the ambient temperature may likewise be more or less invariant throughout the measurements.

In some embodiments, the step of obtaining at least two images includes the steps of: focusing the optical microscope on a first level of the Z-levels, such as to obtain a first image of one or more first features at the first level, and obtaining from the first image a first reference position based on a location of at least one of the first features; focusing the optical microscope on a second level of the Z-levels, such as to obtain a second image of one or more second features at the second level, and obtaining from the second image a second reference position based on a location of at least one of the second features; and wherein the step of determining the lateral shift comprises comparing the first reference position with the second reference position to determine a deviation indicative of the lateral shift. For example, an indication of the lateral shift may already be obtained by comparing how much the second reference position shifts with respect to the first. For example, if the features are provided by concentric shapes to form the calibration structure, the midpoints of these shapes must coincide. If a deviation is found therein, where one of the midpoints is laterally shifted with respect to the other, this is indicative of the mutual lateral shift between the two Z-levels associated with the first and second features imaged. In a different example, if the location of two features is known, then a lateral shift may immediately be determined from the images. Further, if two features at two levels coincide (or have at least a coinciding part), the shift may also directly be determined from the comparison (for example, in case the calibration structure is formed by a standing pole or bar, extending in the Z-direction).

In some of these embodiments, determining the deviation comprises determining, from the first and second reference positions, deviation data representative of a distance and direction of the lateral shift, wherein the method further comprises storing of the deviation data as calibration data associated with the second level. The data may be stored in a database of memory (locally or remotely accessible via a network) in a table, algorithm, or set of data points, to be used by the SPM system during measurement.

In some of the above embodiments, the calibration structure comprises a plurality of concentric structures at the different-levels, such as concentric rings, squares, triangles or polygons, and wherein determining the first and second reference position comprises determining a centroid of the structure at the respective first or second level. As already mentioned above, the centroids of the concentric shapes must coincide, hence if differences exist therebetween then these are indicative of a lateral shift between the levels considered.

In some embodiments, the step of determining the lateral shift further comprises: determine, from a calibration structure data in a data repository, corresponding actual positions of the first and second reference positions obtained from the first and second image; determining from the corresponding actual positions an actual difference vector data between the actual position of the first reference position and the actual position of the second reference position; determining from the first and second reference positions as obtained from the first and second image, an imaged difference vector data between the first reference position and the second reference position; and comparing the actual difference vector data with the imaged difference vector data to determine the deviation indicative of the lateral shift. In these embodiments, the images obtained are compared using data of the actual positions of the features of the calibration structure. This information may be pre-stored in a database or memory. For example, the calibration structure may be located on the metrology frame or on a substrate holder or other part of the SPM system such that the exact location of the calibration structure and it's features, is fixed and may be known. This may be made available as calibration data, enabling the above method. From this, the lateral shifts of a plurality of features may be determined quickly and accurately.

In some embodiments, the step of obtaining at least two images includes focusing the optical microscope on a plurality of different levels and obtaining at each level a reference position based on a location of at least one feature at the respective level, and wherein the step of determining the lateral shift comprises: calculating from the reference positions, for each respective level, deviation data indicative of an associated lateral shift at that respective level; and storing the deviation data associated with each level as calibration data in a data repository accessible by the scanning probe microscopy system.

In some embodiments, for obtaining the at least two images, the optical microscope comprises a camera cooperating with a focusing objective, wherein the camera and focusing objective are set such as to obtain a field of view by the camera wherein the field of view includes at least a part of an outermost periphery of the calibration structure. This provides an optimally wide z-height range. The more z-level elements of the calibration structure are within the field of view, the more different z-levels can be calibrated for. If a complete periphery is within the field of view, a reference XY location may most accurately be determined by analysing the image (e.g. to determine the centroid of a circle). If at least a part of the periphery is within the field of view, at least the corresponding z-level of that peripheric structure can be taken along in the calibration.

In some embodiments, the calibration structure comprises one or more structural features providing the features at different Z-levels, wherein the structural features include one or more side walls for supporting elevated faces of the structural features at the respective Z-levels, wherein at least one of the side walls includes a lateral retracted portion with respect to the respective elevated face such as to be hidden from a view of the optical microscope. The laterally retracted portions will not be visible in the image, and will thus not blur the view on the edge of the elevated face. A sharp image of this edge may thus be obtained which enables to determine the lateral shift accurately.

In some embodiments, the calibration structure comprises one or more structural features providing the features at different Z-levels, wherein the structural features include one or more elevated faces at the respective Z-levels, and wherein the elevated faces include edges defining a periphery of the elevated faces, wherein at least one of the edges comprises a contrasting colour. Similar to the above, by using a different contrasting colour, the sharpness of the edge in focus is improved and the lateral shift may be determined accurately.

In accordance with a second aspect, there is provided a calibration structure for use in a method according to the first aspect, for cooperating with an optical microscope of a scanning probe microscopy system, the calibration structure being a spatial structure including structural features at different Z-levels relative to a Z-axis, for enabling the steps of: obtaining, with the optical microscope, at least two images of at least a part of the calibration structure, wherein the at least two images are focused in at least two different levels of the Z-levels; and determining a lateral shift, in a direction perpendicular to the Z-axis, of the calibration structure as depicted in the at least two images focused in the at least two different levels.

In accordance with a second aspect, there is provided a substrate carrier for use in a scanning probe microscopy device, the substrate carrier comprising a carrier surface for supporting a substrate to be examined with the scanning probe microscopy device, wherein the substrate carrier comprises a calibration structure in accordance with the second aspect.

Furthermore, in accordance with a second aspect, there is provided a scanning probe microscopy device comprising a substrate carrier for supporting a substrate to be examined, the scanning probe microscopy device comprising a probe head including probe comprising a cantilever and a probe tip, the probe head further including an optical beam detector arrangement for monitoring a deflection of the probe tip during scanning, wherein the scanning probe microscopy device further comprises an optical microscope configured for providing a reference data for enabling positioning of the probe tip in a desired measurement location on the surface of the substrate, wherein the optical microscope comprises a focusing objective for focusing the an image obtained with the microscope at a desired Z-level in relation to a Z-axis, the Z-axis being perpendicular to the surface of the substrate, and wherein the substrate carrier comprises a calibration structure in accordance with the second aspect for calibrating the optical microscope.

### BRIEF DESCRIPTION OF THE DRAWINGS

The invention will further be elucidated by description of some specific embodiments thereof, making reference to the attached drawings. The detailed description provides examples of possible implementations of the invention, but is not to be regarded as describing the only embodiments falling under the scope. The scope of the invention is defined in the claims, and the description is to be regarded as illustrative without being restrictive on the invention. In the drawings:

FIG. 1 schematically illustrates a scanning probe microscopy system in accordance with an embodiment;

FIG. 2A schematically illustrates an optical microscope for use in the system of FIG. 1 and which can be calibrated using an embodiment of the invention;

FIG. 2B illustrates the problem of lateral shift during refocusing in an optical microscope as illustrated in FIG. 2A;

FIG. 3 schematically illustrates an optical microscope of a scanning probe microscopy system in accordance with the present invention;

FIGS. 4A and 4B schematically illustrate a method in accordance with an embodiment of the invention;

FIGS. 5A and 5B schematically illustrate a calibration structure in accordance with an embodiment of the invention;

FIGS. 6A and 6B schematically illustrate a calibration structure in accordance with an embodiment of the invention;

FIGS. 7A and 7B schematically illustrate an example of a method in accordance with an embodiment of the invention;

FIG. 8 schematically illustrates a calibration structure in accordance with an embodiment of the invention;

FIG. 9 schematically illustrates a sidewall of a part of a calibration structure in accordance with an embodiment of the invention;

FIG. 10 schematically illustrates a calibration structure in accordance with an embodiment of the invention;

FIG. 11 illustrates schematically illustrates a method in accordance with an embodiment of the invention;

FIG. 12 schematically illustrates a method in accordance with an embodiment of the invention.

### DETAILED DESCRIPTION

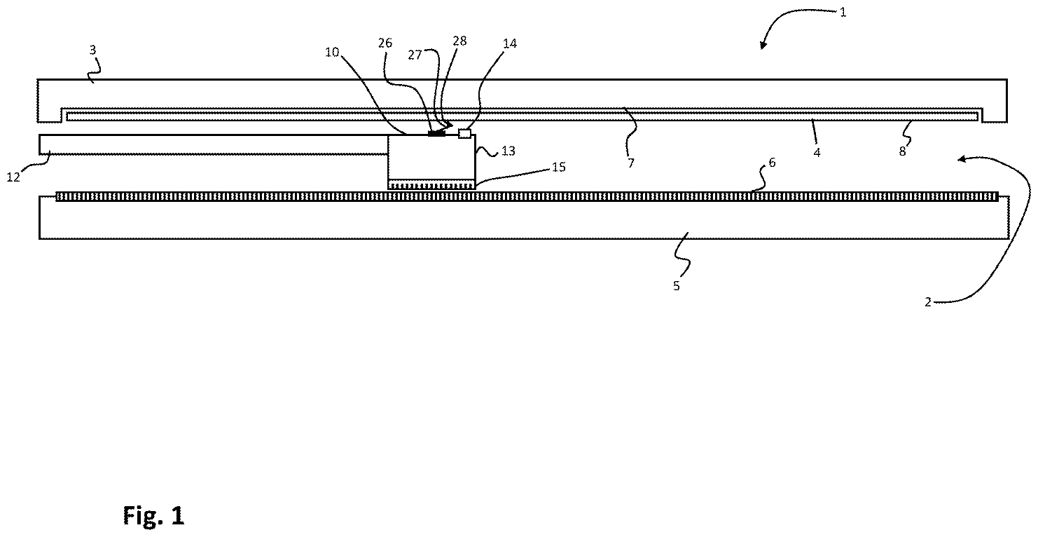

In FIG. 1, the scanning probe microscopy (SPM) system 1 comprises a base 5 and a substrate carrier 3. The substrate carrier 3 includes a bearer surface 7 onto which a substrate 4 may be placed. The substrate 4 may be placed such that a surface 8 thereof, which is to be examined using the SPM system, faces the base 5. The base 5 comprises a coordinate reference grid plate 6. The coordinate reference grid plate is part of a grid encoder, which consists of the plate 6 and at least one encoder 15. Typically, in the system 1 in accordance with the present invention, a plurality of encoders cooperate with the grid plate 6. For example, each element that is moving within the working space 2 between the sample carrier 3 and the grid plate 6 may comprise an encoder 15 that cooperates with the grid plate 6 in order to determine its position on the grid plate 6. The encoder 15, and each other encoder cooperating with the coordinate reference grid plate 6, reads the reference grid in order to obtain the coordinate data of its current location on the grid 6. In FIG. 1, the encoder 15 is mounted on a support 13 providing the scan head 10, which is connected to an arm 12 of a positioning unit module. The support 13 comprises an optical sensor 14, the encoder 15 and a probe 26 including a cantilever 27 and a probe tip 28 for scanning the surface 8 of a substrate 4.

To examine the substrate 4, the probe tip 28 is brought in contact with the substrate surface 8 at a desired location, and an area of the substrate surface 8 is scanned using the probe tip 28. The probe tip 28 thereby encounters the various nanometer or tens of nanometer sized features on the surface 8, which changed the deflection of the cantilever 27. This can be measured using sensing arrangement, which typically includes an optical beam deflection (OBD) arrangement (not shown) wherein the position of the probe tip 28 is monitored by a laser beam impinging on the back side of the probe tip 28 and reflected back towards an optical sensor (four quadrant photodetector). As may be appreciated, other suitable deflection detection methods may be applied as an alternative to the above, or additionally thereto—for example, piezoelectric, piezoresistive or capacitive sensing methods. The probe 26 may be scanned with the probe tip 28 in contact mode, non-contact mode, tapping mode, or any other mode. Furthermore, the SPM system 1 may perform an acoustic or ultrasonic measurement technique to investigate structures below the surface 8.

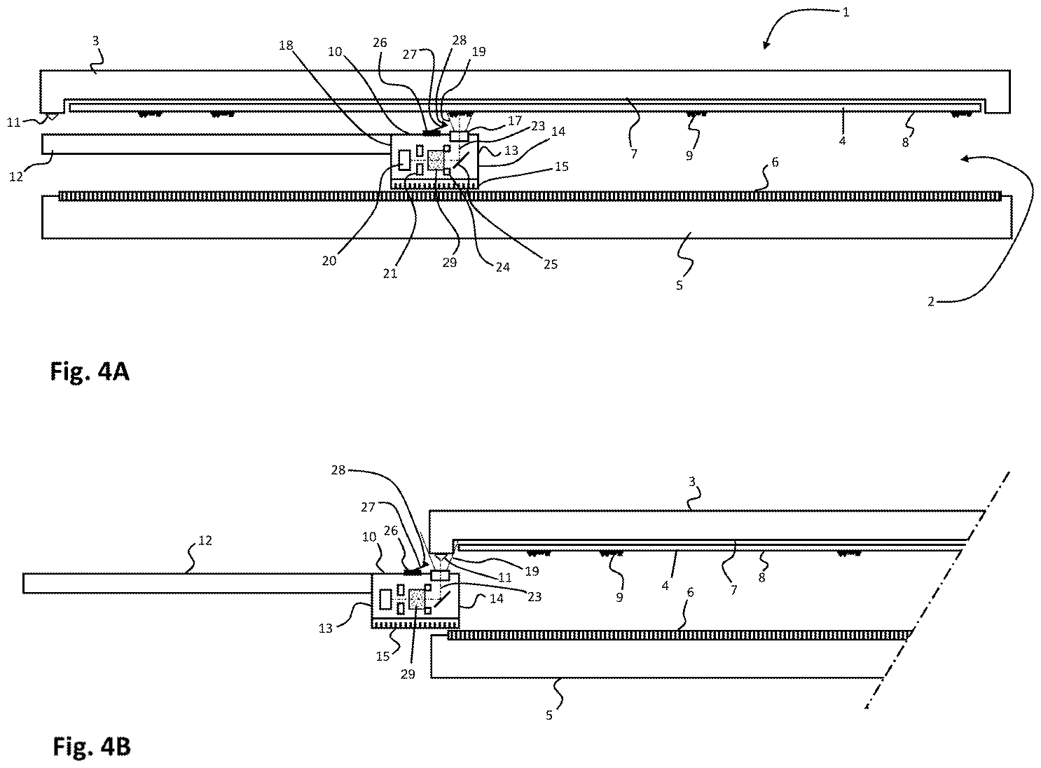

The optical sensor 14 may be applied to support correct positioning of the probe tip on the surface in a fast and reliable manner. The optical sensor 14 enables to aid in navigation across the surface 8, in the approach method to place the probe tip 28 onto the surface, and in calibrating the system, e.g. by observing fiducial markers 9 (e.g. FIG. 4A) or determination of the exact location of the probe tip 28 relative to the system (e.g. after each replacement thereof). Preferably, for all these purposes, the optical sensor 14 needs to be as accurate as possible, and also it's location within the system 1 (e.g. relative to fixed points on the arm 12 or in relation to the base 5 or substrate carrier 3) needs to be known. In the embodiments discussed herein, the optical sensor 14 is a microscopic sensor, but the invention is not limited to a specific design.

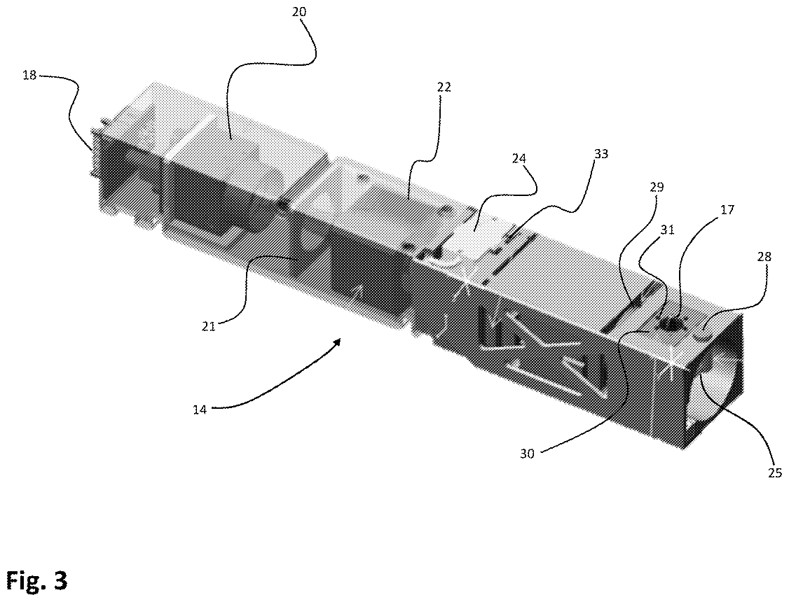

An example of an optical sensor 14 that may be used in the system of FIGS. 1, 4a and 4b, is illustrated in FIG. 3 which provides a see-through impression of the optical sensor 14. The optical sensor 14 consists of a camera 20, for example a CMOS camera to obtain images of the substrate surface. Alternatively, a CCD camera may be applied or a different type of optical sensor unit. The sensor further consists of an aperture 21, and a tube lens 22. The tube lens 22 connects to an actuator that enables to adjust the distance between the camera 20 and the tube lens 22 in order to focus the image of the substrate surface 8 or the surface to be imaged onto camera 20 to obtain a sharp image.

The lens system is infinity corrected. At the front side, the optical sensor 14 further consists of a sensor opening 17 and includes a redirection mirror 25 which makes an angle of π/4 radians with the longitudinal axis through the sensor 14 in order to redirect the view of the imaging plain of the surface 8 of the substrate to the lens system. Furthermore, the optical sensor 14 comprises an infinity corrected microscopy objective 29 with a long working distance, which is used to obtain a correct focus on the Z-level perpendicular to the sample surface 8. The numeric aperture of this objective 29 for example may be 0.28. The objective 29 may likewise be moved, using a precision actuator 24 suspending with flexures 33 from a structure of the optical sensor 14, along the optical axis 23 through the lens system in order to obtain focus at an exact Z-level. The actuator 24 may be a piezo actuator and the flexures 23 may be provided by bending elements or leaf springs or a system of leaf springs to allow very accurate focusing adjustment and stability. The magnification of the resulting optical microscope (as a result of combination of tube lens 22 and objective 29) for example may be three times to twenty times, and in the present example provides a five times magnification.

The optical sensor 14 further comprises a printed circuit board 30 onto which for example a plurality of light emitting diodes 31 (LED's) provide illumination of the substrate surface for imaging. Also, capacitive sensor 32 enables to determine the distance to the substrate surface in order to perform correct focusing of the image quickly. The capacitive sensor 32 may further be applied to perform additional measurements from which e.g. a tilting of the substrate relative to the grid plate 6 may be determined.

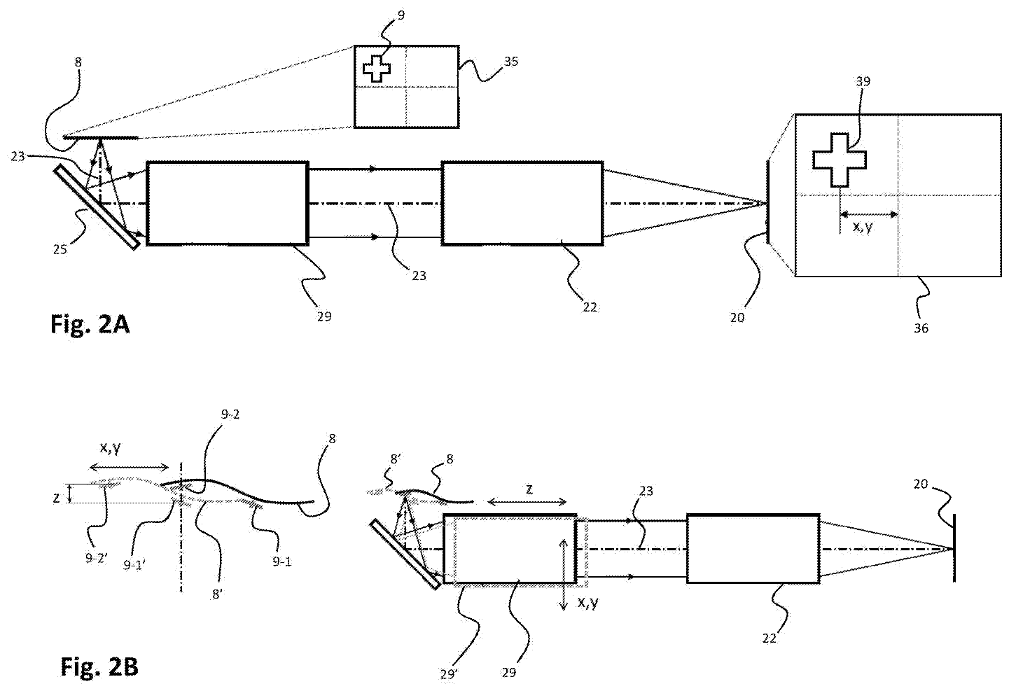

An optical sensor 14 is schematically illustrated in FIGS. 2A and 2B, consisting of the optical microscope system explained in relation to FIG. 3 above. In FIG. 2A, the objective 29 can be precisely moved in the direction along optical axis 23 in order to adjust the focus of the system onto the surface 8. In the situation illustrated, the surface 8 in the area 35 at the location imaged includes a recognizable feature 9. This image is obtained by focusing lens 29 onto the correct Z-level on the surface 8, after which it is focused by tube lens 22 on the camera 20. The image 36 is obtained with camera 20, from which the location (X,Y) on the surface 8 as well as the size of feature 9 can be obtained.

FIG. 2B shows what may typically be encountered by refocusing lens 29 at a different Z-level. On the left side of the figure, it can be seen that the surface 8 is not completely flat, and features may be in focus at different Z-levels. Suppose, the lens 29 is first focused on feature 9-2 and thereafter refocused on feature 9-1 at a different Z-level as indicated. To do so, in the right hand side of the figure, lens 29 is to be moved to a different position along the optical axis 23, ending up at the location indicated by 29′. However, due to the movement, despite the actuator 24 being highly precise, a slight sideways displacement may be introduced. This displacement is visible as a lateral shift in the image: the surface 8 appears to have been shifted to position 8′. As a result, the location of feature 9-1 is due to the refocusing of lens 29 also shifted in the image obtained with camera 20.

FIG. 4A shows part of a scanning probe microscopy system 1 in accordance with an embodiment and including a scan head 10 with an optical sensor 14 in use, and in FIG. 4B a method of calibrating the optical sensor 14 in accordance with an embodiment is illustrated. The optical sensor 14 provides an important aspect of the invention and, in the illustrated embodiment, includes a miniature camera unit 20 having a field of view 19 through its sensor opening 17. The optical sensor 14 further comprises an aperture 21, a focusing lens 22 and actuators 24. The actuators 24 enable to adjust the distance between the camera 20 and the focusing optics 22 for enabling focusing of the image on the surface of the substrate 8. Furthermore, in order to make use of the available space parallel to the surface of the grid plate 6 in the working space 2, a mirror 25 redirects the field of view of the camera 20 from a horizontal into a vertical direction as illustrated in FIG. 4a. The optical sensor 14 is mechanically fixed to the support 13 and the arm 12, as will be described later. Furthermore, electrical connections for data transfer to the system 1 are provided via the electrical connection interface 18.

The camera 20 is accurate enough to be able to recognize alignment marks on the wafer. The sizes of such marks are typically within a range of 20*20 micrometer up to 50*50 micrometer, but of course the size of these marks may vary and may become smaller as technology develops. The invention is not limited in this respect. The resolution of the image features of alignment marks may typically be down to 1 micrometer, which may likewise be subject to change (i.e. decrease) over time. The camera 20 may be adapted accordingly dependent on the size and/or resolution of the alignment marks, and should be able to distinguish the necessary image features in order to carry out its task. For example, pixel resolution of camera 20 in the object plane (e.g. surface to be read, bearing the marks) may be smaller than or equal to 2 micrometer, preferably smaller than or equal to 1.0 micrometer, more preferable smaller than or equal to 0.5 micrometer. Furthermore, the camera may be able to operate with at least two magnification factors for low and high magnification. The camera must be able to detect alignment features on a wafer surface, which may be placed as close as 1 millimeter from the edge of the wafer. Power consumption of the camera is preferably as low as possible to reduce thermal dissipation and unwanted effects on the accuracy. The field of view 19 of camera 20 may be at least 0.5 millimeter, preferably at least 0.9 millimeter.

In FIG. 4B, in accordance with a method of the invention, the arm 12 is retracted to a position such that the optical sensor 14 can be focused on calibration structure 11. The calibration structure 11 may be located on the substrate carrier 3, on a surface thereof next to the substrate 4. To perform calibration, a number of different levels of the calibration structure 11 may be imaged by refocusing the objective 29 at the correct level. This will enable to obtain a plurality of images from which the mutual lateral shift can be determined, which is indicative of the error caused by refocusing at each of the imaged z-levels.

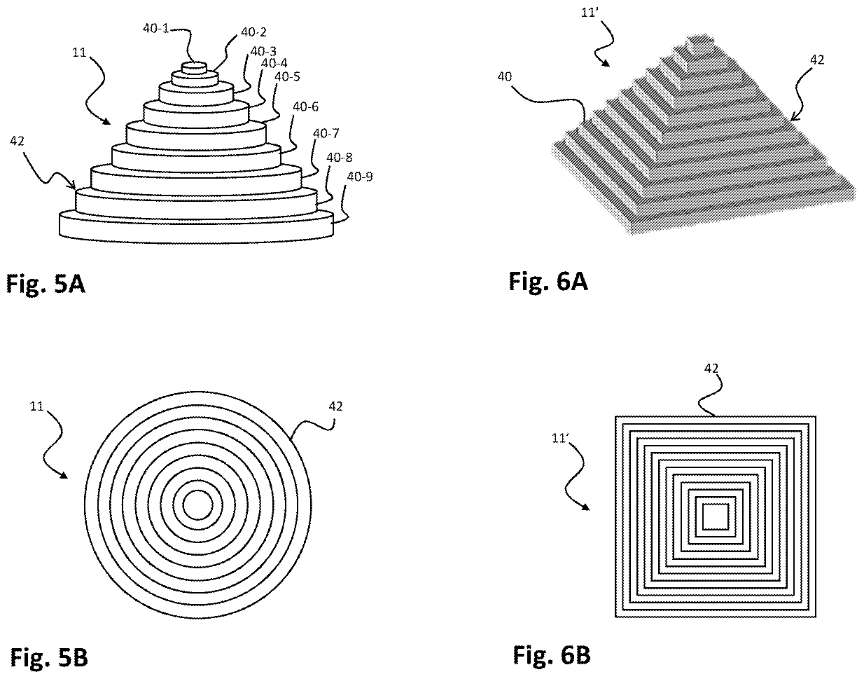

FIGS. 5A, 5B, 6A and 6B illustrate two different embodiments of calibration structure in accordance with the present invention. The invention is not limited to this particular type of structure, and neither to the application of concentric shapes, but in principle any desired design of the calibration structure 11 may be applied, as long as there are features in at least two different z-levels. In the embodiment of FIGS. 5A and 5B, the calibration structure 11 is formed by a plurality of stacked disc shaped structural features 40-1, 40-2, . . . , 40-8, 40-9. Each of the structures 40-1 through 40-9 includes a contrasting edge 42 that is visible in the field of view of the microscope when focus thereon. It is not essential that the edge 42 has a contrasting color, however in accordance with some embodiments these edges 42 may be fabricated with a color that is contrasting from the surroundings. This allows a sharp focus of the optical sensor 14 on the edge. As can be seen in FIG. 5B, the edges 42 of the structures 40-1 through 40-9 together form a plurality of concentric circles as viewed from above in the field of view of the optical sensor 14.

Alternatively, or additionally, the calibration structure 11 may contain features having a different shape. In FIG. 6A, an alternative calibration structure 11′ is formed of concentric squares that are stacked upon each other at different levels. The squares 40 likewise include edges 42, and as viewed from above in FIG. 6B, these edges form a plurality of concentric squares in the field of view of the optical sensor 14.

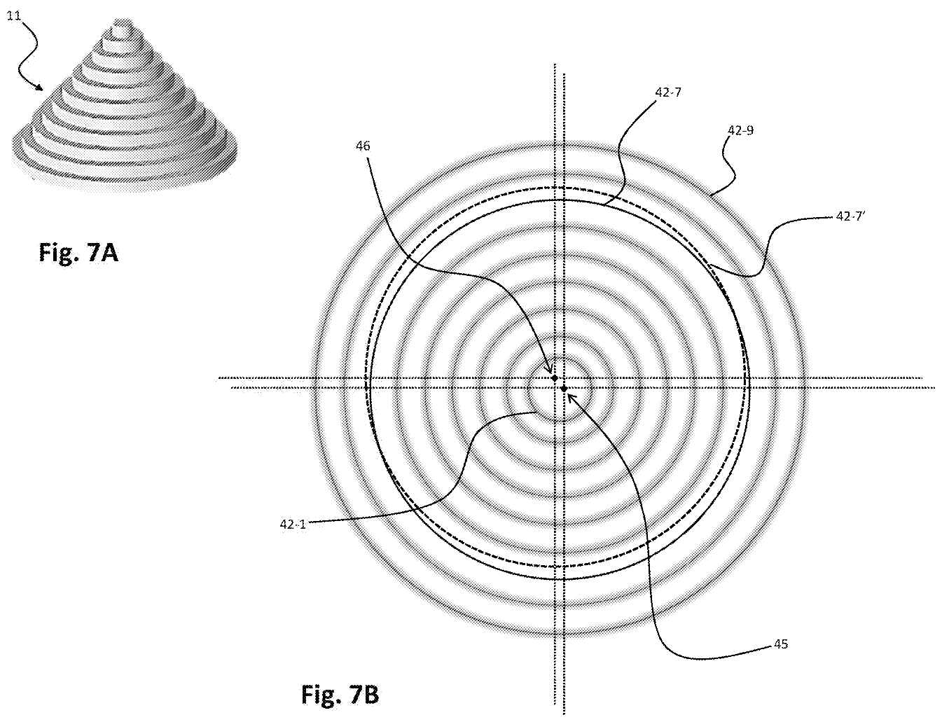

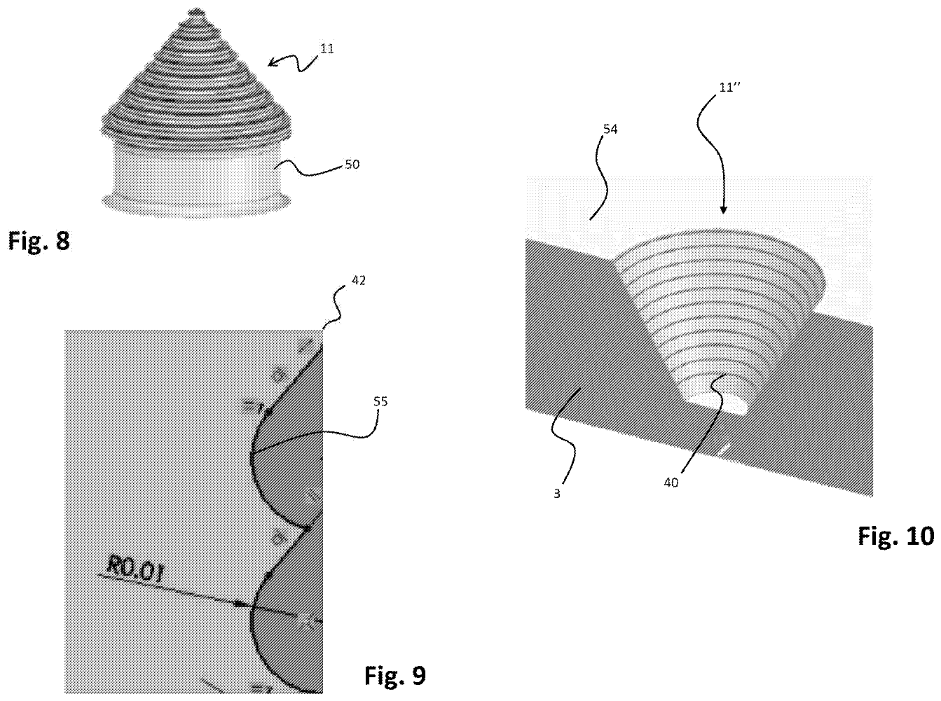

FIG. 7A shows the calibration structure 11 that is similar to the calibration structure 11 of FIG. 5A. In FIG. 7B, an enlargement of the concentric circles in the field of view of the optical sensor 14 is illustrated. The edges 42 of each of the concentric circles are numbered 42-1 through 42-9. In the situation in FIG. 7B, the optical sensor 14 is in focus at the level coinciding with edge 42-7. As can be seen in FIG. 7B, the edge 42-7 is sharply in focus, while the other edges 42-1 through 42-6 and 42-8 and 42-9 are blurred. The illustration, in this respect, is schematic: in reality, the farther the circle from the focus, the blurrier it typically is. So 42-5 and 42-9 should have more blur than 42-6 and 42-8 and so on (42-1 is the blurriest). The centroid of all the edges 42-1 through 42-9 is given by point 45 in the center of the figure. However, due to the refocusing at the level coinciding with edge 42-7, the lens 29 has been slightly displaced off-axis 23. As a result, the whole image illustrated in FIG. 7B has likewise been shifted laterally. The circle 42-7′ illustrates the real location of the edge 42-7 that would have been found if no lateral shift would have occurred. In order to determine the magnitude of the lateral shift at each z-level, images may be made at each of the levels 42-1 through 42-9, by constantly refocusing for each image to the respective z-level to be imaged. At each z-level, the centroid may be calculated. The centroid of all the concentric circles in the figure should, at any z-level, coincide in the middle of the figure. However, the centroids will slightly shift in the X and Y direction dependent on the z-level in focus, caused by the off-axis displacement of the lens 29. For example, the centroid of the circle 42-7′ is indicated by midpoint 46, and for example could have been found while in focus at level 42-1. By calculating the deviations, at each z-level a calibration value may be obtained that enables to calibrate the system and in use correct for lateral shifts caused by different z-levels in focus.

Turning to FIG. 8, a further embodiment of a calibration structure 11 is illustrated. The calibration structure 11 of FIG. 8 includes a stem 50 that elevates the base of the cone formed by the calibration structure 11. The stem 50 may be matched with a typical thickness of a wafer, such that if the stem will be placed next to a substrate, the z-levels of the calibration structure 11 will more or less correspond to the range of z-levels to be covered in use by the SPM system 1.

FIG. 9 illustrates a retraction of the side walls 55 of the structures that together form the calibration structure 11. At each z-level, an edge 42 is present, and below the edge 42 a sidewall 55 will extend to the next lower level of the calibration structure 11. By shaping the sidewall 55 such that it is retracted compared to the edge 42, a better focus of the edge 42 may be obtained because the material from the calibration structure below the edge 42 is not visible in the field of view.

In FIG. 10, a further alternative calibration structure 11′ is shown. Here, the calibration structure 11′ is provided by a hole in the material of the substrate carrier 3. In the surface 54 of the substrate carrier 3, the hole 11″ is formed providing terraces 40 at a plurality of different levels. As may be appreciated, in the field of view of the optical sensor 14, this will provide a similar image as the image that is illustrated in FIGS. 5B and 7B.

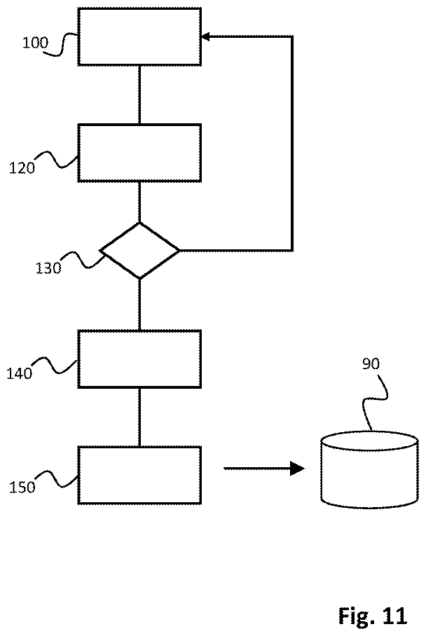

FIG. 11 schematically illustrates a method in accordance with an embodiment of the present invention. In the method of the present invention, in a first step thereof a first image of the calibration structure 11 is obtained which is focused in one of the z-levels coinciding with the edges 42 of the calibration structure 11. Next, in step 120, from the image obtained in step 110 a first reference position is calculated that can be used in order to determine lateral shift. For example, in the example of FIG. 7B the centroid of the concentric circles was calculated. Alternatively or additionally, a fixed known point of the structures may be used as reference point. For example, it is also possible to determine the exact location of one or more corner points of the edge 42 that is in focus of the calibration structure 11′ in FIGS. 6A and 6B. Alternative suitable reference positions may likewise be calculated, as will be appreciated by the skilled person. In step 130, it is determined whether or not a next level of the calibration structure needs to be imaged. If a further z-level of the calibration structure 11 needs to be imaged, then after step 130 the method continues again in step 100. Otherwise the method continues in step 140. In step 140, from the reference positions obtained for each of the z-levels in step 120, the lateral shift is determined at each z-level, to be used as calibration data. Next, in step 150, the calibration data is stored in a memory 90 of the SPM system. Alternatively, an external memory or database may be used in order to store the calibration data, which external database may be accessible through a data network.

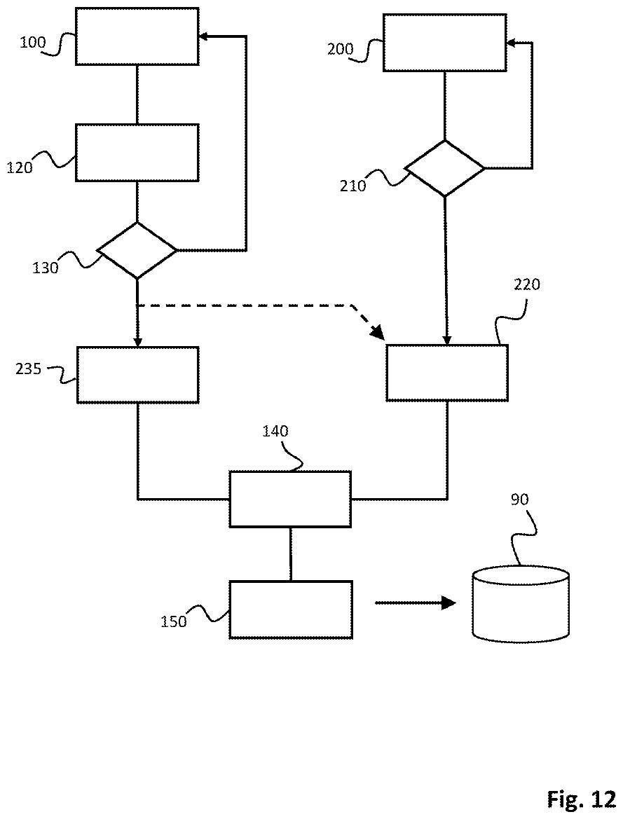

In FIG. 12, an alternative embodiment of a method in accordance with the present invention is illustrated. Here, the steps 100, 120 and 130 are similar to the method of step 11, and include the taking of images at a plurality of z-levels of the calibration structure 11 as well as the calculation of reference positions therefrom. Parallel thereto, in step 200, the SPM system 1 may access a data repository, such as a database or memory in order to obtain information about the calibration structure 11 that is being considered. For example, the calibration structure 11 may be a fixed calibration structure integrated in the SPM system 1, and calibration data indicating the exact location of the calibration structure 11 and each of its structures 40 at the various z-levels may be stored in the memory. In case of concentric circles, for example, the exact centroid position of the circles formed by edges 42 may be stored in the memory of the SPM system 1. Thus, in step 200 for each reference position, the actual position is obtained from the memory. In step 210, it is determined whether a next actual position of a reference position may be obtained from the memory.

Then, in step 220, it is determined from the corresponding actual positions obtained in step 200 and the reference positions in step 120, difference factor data of a vector between the actual positions of the first reference position and the actual position of the second reference position. For example, consider the use of the corner points of the edges 42 of FIG. 6B. Suppose for each of the structures 40 in FIG. 6B, one of the corner points of the edges 42 is used as reference position. Then in step 200, the actual positions corresponding to each of these reference points may be obtained from memory. This is possible because the exact position of the calibration structure 11′ in the SPM system 1 is known, and these positions may therefore have been stored as system calibration data upon manufacturing. In step 220, having these actual positions corresponding to the reference positions from step 120, vector data can be determined between each two reference positions. For example, the vector between the first corner point of the outer most square and the next corner point of the subsequent square can be determined as being a true vector between these points. Then, in step 235, the system 1 determines from the reference positions obtained in step 120, the imaged difference vector data between each two reference positions from the images obtained in step 100. Next, in step 140, the system calculated the differences between the actual difference vector data obtained in step 220 and the imaged difference vector data obtained in step 235, in order to determine the deviation that is indicative of the lateral shift at each z-level. This information is stored as calibration data in step 150 in the memory or external database 90.

The present invention has been described in terms of some specific embodiments thereof. It will be appreciated that the embodiments shown in the drawings and described herein are intended for illustrated purposes only and are not by any manner or means intended to be restrictive on the invention. It is believed that the operation and construction of the present invention will be apparent from the foregoing description and drawings appended thereto. It will be clear to the skilled person that the invention is not limited to any embodiment herein described and that modifications are possible which should be considered within the scope of the appended claims. Also kinematic inversions are considered inherently disclosed and to be within the scope of the invention. Moreover, any of the components and elements of the various embodiments disclosed may be combined or may be incorporated in other embodiments where considered necessary, desired or preferred, without departing from the scope of the invention as defined in the claims.

In the claims, any reference signs shall not be construed as limiting the claim. The term ‘comprising’ and ‘including’ when used in this description or the appended claims should not be construed in an exclusive or exhaustive sense but rather in an inclusive sense. Thus the expression ‘comprising’ as used herein does not exclude the presence of other elements or steps in addition to those listed in any claim. Furthermore, the words ‘a’ and ‘an’ shall not be construed as limited to ‘only one’, but instead are used to mean ‘at least one’, and do not exclude a plurality. Features that are not specifically or explicitly described or claimed may be additionally included in the structure of the invention within its scope. Expressions such as: “means for . . . ” should be read as: “component configured for . . . ” or “member constructed to . . . ” and should be construed to include equivalents for the structures disclosed. The use of expressions like: “critical”, “preferred”, “especially preferred” etc. is not intended to limit the invention. Additions, deletions, and modifications within the purview of the skilled person may generally be made without departing from the spirit and scope of the invention, as is determined by the claims. The invention may be practiced otherwise then as specifically described herein, and is only limited by the appended claims.

1. A method of calibrating, in a scanning probe microscopy system, an optical microscope configured for providing a reference data for positioning a probe tip on a surface of a substrate, wherein the calibration is performed using a calibration structure being a spatial structure including features at different Z-levels relative to a Z-axis, the Z-axis being perpendicular to the surface of the substrate, wherein the method comprises the steps of:
obtaining, with the optical microscope, at least two images of at least a part of the calibration structure, wherein the at least two images are focused in at least two different levels of the Z-levels; and
determining a lateral shift, in a direction perpendicular to the Z-axis, of the calibration structure as depicted in the at least two images focused in the at least two different levels.

2. The method according to claim 1, wherein the step of obtaining at least two images is performed by obtaining a series of images of the calibration structure during a refocusing of the optical microscope across a range of Z-levels, and wherein the step of determining a lateral shift is performed by detecting a moving of the calibration structure across the series of images.

3. The method according to claim 1, wherein the step of obtaining at least two images includes the steps of:
focusing the optical microscope on a first level of the Z-levels, such as to obtain a first image of one or more first features at the first level, and obtaining from the first image a first reference position based on a location of at least one of the first features;
focusing the optical microscope on a second level of the Z-levels, such as to obtain a second image of one or more second features at the second level, and obtaining from the second image a second reference position based on a location of at least one of the second features; and
wherein the step of determining the lateral shift comprises comparing the first reference position with the second reference position to determine a deviation indicative of the lateral shift.

4. The method according to claim 3, wherein determining the deviation comprises determining, from the first and second reference positions, deviation data representative of a distance and direction of the lateral shift, wherein the method further comprises storing of the deviation data as calibration data associated with the second level.

5. The method according to claim 3, wherein the calibration structure comprises a plurality of concentric structures at the different-levels, and wherein determining the first and second reference position comprises determining a centroid of the structure at the respective first or second level.

6. The method according to claim 3, wherein the step of determining the lateral shift further comprises:
determining, from a calibration structure data in a data repository, corresponding actual positions of the first and second reference positions obtained from the first and second image;
determining from the corresponding actual positions an actual difference vector data between the actual position of the first reference position and the actual position of the second reference position;
determining from the first and second reference positions as obtained from the first and second image, an imaged difference vector data between the first reference position and the second reference position; and
comparing the actual difference vector data with the imaged difference vector data to determine the deviation indicative of the lateral shift.

7. The method according to claim 1, wherein the step of obtaining at least two images includes focusing the optical microscope on a plurality of different levels and obtaining at each level a reference position based on a location of at least one feature at the respective level, and wherein the step of determining the lateral shift comprises:
calculating from the reference positions, for each respective level, deviation data indicative of an associated lateral shift at that respective level; and
storing the deviation data associated with each level as calibration data in a data repository accessible by the scanning probe microscopy system.

8. The method according to claim 1, wherein for obtaining the at least two images, the optical microscope comprises a camera cooperating with a focusing objective, wherein the camera and focusing objective are set such as to obtain a field of view by the camera wherein the field of view includes at least a part of an outermost periphery of the calibration structure.

9. The method according to claim 1, wherein the calibration structure comprises one or more structural features providing the features at different Z-levels, wherein the structural features include one or more side walls for supporting elevated faces of the structural features at the respective Z-levels, wherein at least one of the side walls includes a lateral retracted portion with respect to the respective elevated face such as to be hidden from a view of the optical microscope.

10. The method according to claim 1, wherein the calibration structure comprises one or more structural features providing the features at different Z-levels, wherein the structural features include one or more elevated faces at the respective Z-levels, and wherein the elevated faces include edges defining a periphery of the elevated faces, wherein at least one of the edges comprises a contrasting colour.

11. A substrate carrier for use in a scanning probe microscopy device, the substrate carrier comprising a carrier surface for supporting a substrate to be examined with the scanning probe microscopy device, wherein the substrate carrier comprises a calibration structure for use in the method according to claim 1, for cooperating with an optical microscope of a scanning probe microscopy system, the calibration structure being a spatial structure including structural features at different Z-levels relative to a Z-axis, for enabling the steps of:
obtaining, with the optical microscope, at least two images of at least a part of the calibration structure, wherein the at least two images are focused in at least two different levels of the Z-levels; and
determining a lateral shift, in a direction perpendicular to the Z-axis, of the calibration structure as depicted in the at least two images focused in the at least two different levels.

12. The scanning probe microscopy device comprising a substrate carrier for supporting a substrate to be examined, the scanning probe microscopy device comprising a probe head including probe comprising a cantilever and a probe tip, the probe head further including an optical beam detector arrangement for monitoring a deflection of the probe tip during scanning, wherein the scanning probe microscopy device further comprises an optical microscope configured for providing a reference data for enabling positioning of the probe tip in a desired measurement location on the surface of the substrate, wherein the optical microscope comprises a focusing objective for focusing the an image obtained with the microscope at a desired Z-level in relation to a Z-axis, the Z-axis being perpendicular to the surface of the substrate, and
wherein the substrate carrier comprises, for calibrating the optical microscope, a calibration structure for use in the method according to claim 1, for cooperating with an optical microscope of a scanning probe microscopy system, the calibration structure being a spatial structure including structural features at different Z-levels relative to a Z-axis, for enabling the steps of:
obtaining, with the optical microscope, at least two images of at least a part of the calibration structure, wherein the at least two images are focused in at least two different levels of the Z-levels; and
determining a lateral shift, in a direction perpendicular to the Z-axis, of the calibration structure as depicted in the at least two images focused in the at least two different levels.

13. The scanning probe microscopy device in accordance with claim 12, wherein for focusing the optical microscope, the focusing objective cooperates with a precision actuator for moving the focusing objective along an optical axis, and wherein the scanning probe microscopy device further comprises a controller for controlling the precision actuator for performing the focusing, the controller cooperating with a camera for receiving images obtained using the optical microscope, and wherein controller is configured for performing the steps of:
obtaining, with the optical microscope, at least two images of at least a part of the calibration structure, wherein the at least two images are focused in at least two different levels of the Z-levels; and
determining a lateral shift, in a direction perpendicular to the Z-axis, of the calibration structure as depicted in the at least two images focused in the at least two different levels.

14. The scanning probe microscopy device in accordance with claim 13, wherein the controller is further configured for:
focusing the optical microscope on a plurality of different levels and obtaining at each level a reference position based on a location of at least one feature at the respective level, and
wherein, for determining the lateral shift, the controller is configured for:
calculating from the reference positions, for each respective level, deviation data indicative of an associated lateral shift at that respective level; and
storing the deviation data associated with each level as calibration data in a data repository accessible by the scanning probe microscopy system.

15. The method according to claim 5, wherein the concentric structures are concentric rings, squares, triangles or polygons.
